(19) United States
(12) Patent Application Publication
(10) Pub. No.: US 2009/0305556 A1
(43) Pub. Date: Dec. 10, 2009

(54) Holding Member, Mounting Structure and Electronic Component

(76) Inventors: Yuzo Kawahara, Kanagawa-ken (JP); Hiroshi Kobayashi, Aichi-ken (JP); Masoto Minakata, Aichi-ken (JP)

Correspondence Address: BARLEY SNYDER, LLC, 1000 WESTLAKES DRIVE, SUITE 275, BERWYN, PA, 19312, US

(21) Appl. No.: 12/092,462

(22) PCT Filed: Oct. 23, 2006
(86) PCT No.: PCT/JP2006/321014

§ 371 Date: Feb. 9, 2009

(30) Foreign Application Priority Data
Nov. 4, 2005 (JP) 2005-321150

(51) Int. Cl. H01R 13/73

(52) U.S. Cl. 439/544

(57) ABSTRACT

A mounting structure includes an electrical circuit board provided with at least one through hole. An electrical component is electrically connected to the electrical circuit board. The electrical component includes an insulating housing. A holding member has a plate-like base fixed to the insulating housing. The base has a protrusion extending there from. Opposing plate-like first legs extend from the protrusion and interfere with an inside surface of the through hole for securing the holding member to the through hole in the electrical circuit board. A plate-like second leg extends from the protrusion in the same direction as the first legs. The second leg is arranged between the first legs.

### CROSS-REFERENCE TO RELATED APPLICATIONS

This application claims the benefit of the filing date under 35 U.S.C. § 120 of International Application No. PCT/JP2006/321014 filed Oct. 23, 2006 that claims the benefit of Japanese Patent Application No. 2005-321150 filed Nov. 4, 2005.

### FIELD OF THE INVENTION

The present invention relates to a holding member that holds an electronic component on an electrical circuit board such that it is fit into a through hole provided in the electric circuit board, a mounting structure comprising the electrical circuit board and the holding member, and an electronic component having the holding member.

### BACKGROUND

Conventional known techniques for mounting large electrical components such as connectors on electrical circuit boards include the technique of fitting a holding member attached to the electronic component into a through hole formed in the electrical circuit board. In addition, there are cases in which a securing bracket is soldered to the electrical circuit board for the purpose of firmly securing the connector to the electrical circuit board. JP H10-162886 A, JP H6-62486 A, JP H9-274975 A, and JP H10-40979 A use board locks and securing brackets that hold connectors, as examples of holding members that hold electronic components.

FIG. 9 is an example of a conventional securing bracket 105. The securing bracket 105 is a flat object formed by stamping a metal sheet. The securing bracket 105 has a shape wherein a press-fit protrusion 154 and a catch 153 are provided on either side on an outside of a pair of securing legs 152 that extend from a head 151 in a forked manner. When the securing bracket 105 is pressed into a mounting hole of connector 102 and a through hole of electrical circuit board 101, the catch 153 passes through the through hole of the electrical circuit board 101 and catches on the electrical circuit board 101. The securing bracket 105 holds the connector 102 so that it does not fall off of the electrical circuit board 101. When pressed in, the securing legs 152 deform elastically in a direction W so that the catches 153 pass through the through hole of the electrical circuit board 101. However, the securing bracket 105 is flat, so the securing legs 152 deform elastically within the plane and the amount of elastic deformation is small. For this reason, the through hole of the electrical circuit board 101 must be formed precisely. In addition, an inside surface of the through hole of the electrical circuit board 101 is typically copper-plated. The copper plating is easily damaged by edges of the securing legs 152 coming into contact with the inside surface of the through hole. In addition, the soldering of the securing bracket 105 to the electrical circuit board 101 is typically performed by means of a solder flow process. The securing of the securing brackets 105 by soldering demands that the securing be done solidly so that excessive forces are not applied to the pins of the connector 102.

### SUMMARY

In view of the aforementioned circumstances, it is an object of the present invention to provide a holding member, a mounting structure and an electronic component having the holding member that are able to adapt even if the precision of the through hole is decreased, the legs can be fit in without damaging the inside surface of the through hole, and moreover, the mounting strength of electronic components to the electrical circuit board after soldering is high.

This and other objects are achieved by a holding member for fitting into a through hole in an electrical circuit board that secures an electrical component to the circuit board. The holding member comprises a plate-like base for securing to the electrical component. The base has a protrusion extending there from. Opposing plate-like first legs extend from the protrusion for securing to the through hole in the electrical circuit board. A plate-like second leg extends from the protrusion in the same direction as the first legs. The second leg is arranged between the first legs.

This and other objects are further achieved by a mounting structure comprising an electrical circuit board provided with at least one through hole. An electrical component is electrically connected to the electrical circuit board. The electrical component includes an insulating housing. A holding member has a plate-like base fixed to the insulating housing. The base has a protrusion extending there from. Opposing plate-like first legs extend from the protrusion and interfere with an inside surface of the through hole for securing the holding member to the through hole in the electrical circuit board. A plate-like second leg extends from the protrusion in the same direction as the first legs. The second leg is arranged between the first legs.

### BRIEF DESCRIPTION OF THE DRAWINGS

FIG. 1 is a perspective view of a holding member according to an embodiment of the present invention.

FIG. 2(a) is a front view of the holding member of FIG. 1.

FIG. 2(b) is plan view of the holding member of FIG. 1.

FIG. 2(c) is a left-side view of the holding member of FIG. 1.

FIG. 2(d) is a back view of the holding member of FIG. 1.

FIG. 3(a) is a plan view of the holding member of FIG. 1 inserted into a through hole of an electrical circuit board.

FIG. 3(b) is a front view of the holding member of FIG. 1 inserted into the through hole of the electrical circuit board.

FIG. 3(c) is a bottom view of the holding member of FIG. 1 inserted into the through hole of the electrical circuit board.

FIG. 4 is a side view of the holding member of FIG. 1 inserted into the through hole of the electrical circuit board the holding member 1 secured to the electrical circuit board by solder in a solder flow process.

FIG. 5 is a cross sectional view of the holding member of FIG. 4.

FIG. 6 is a perspective view showing a connector as one embodiment of an electronic component according to the present invention.

FIG. 7(a) is a side view of the connector of FIG. 6.

FIG. 7(b) is a front view of the connector of FIG. 6.

FIG. 8 is a perspective view of the connector of FIG. 6 mounted on the electrical circuit board.

FIG. 9 is a cross sectional view of a securing bracket according to the prior art.

### DETAILED DESCRIPTION OF THE EMBODIMENT(S)

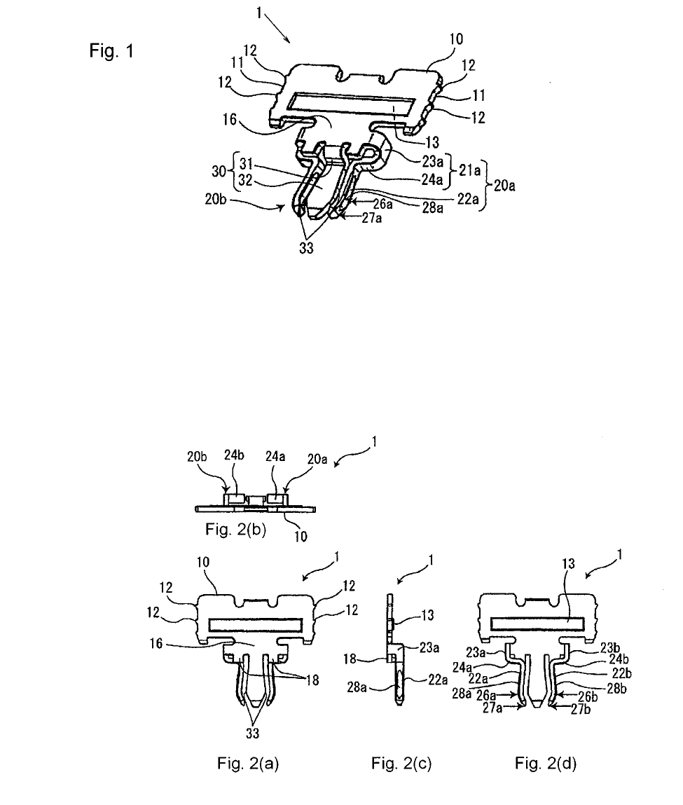

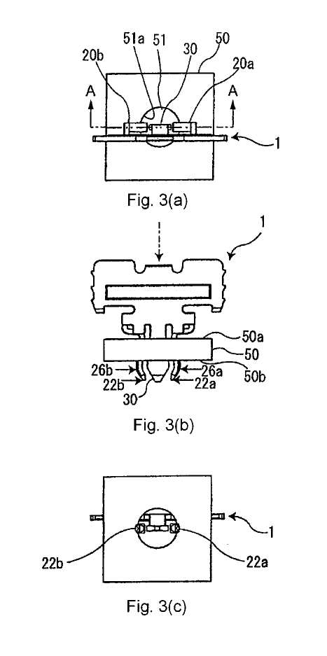

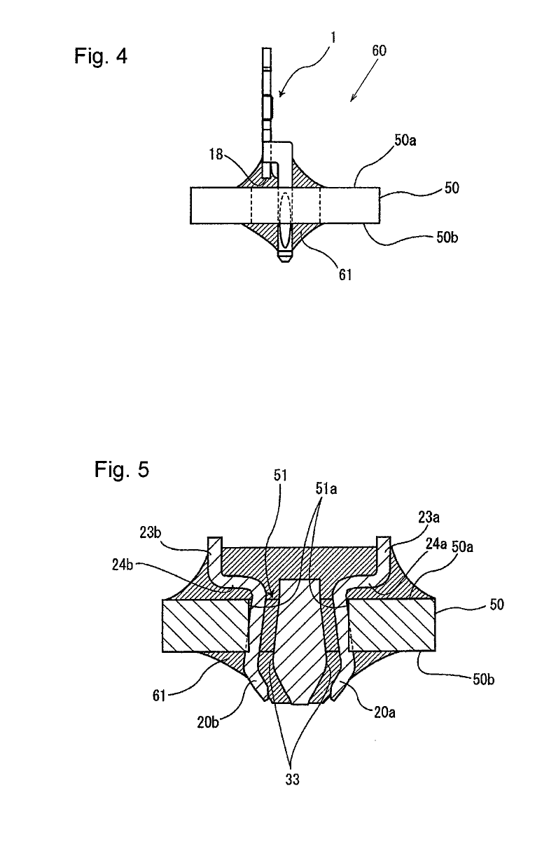

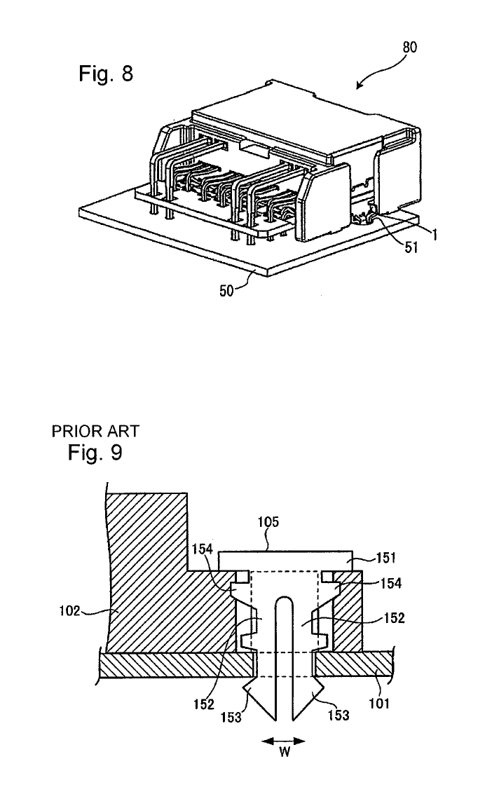

FIGS. 1-2(d) show a holding member 1 according to an embodiment of the present invention. The holding member 1 is to be fitted into a through hole 51 (see FIG. 3(a)) provided in an electrical circuit board 50 (see FIG. 3(a)) to hold a connector 80 (see FIG. 8) to the electrical circuit board 50 (see FIG. 3(a)). The holding member 1 is formed, for example, by stamping, pressing, and forming a sheet of brass. In addition, the holding member 1 is treated by tin plating so that its surface is wetted by molten solder 61 (see FIG. 5).

The holding member 1 comprises a base 10, a pair of plate-like first legs 20a, 20b and a plate-like second leg 30. The base 10 is formed in the shape of a rectangular sheet with a protrusion 16 extending from a center of one edge. Several barbs 12 are provided on side edges 11 of the base 10. The base 10 is pressed into a groove 83 provided in a side surface of an insulating housing 82 of the connector 80 (see FIG. 8). The barbs 12 are provided for the purpose of preventing the holding member 1 from falling out of the connector 80 (see FIG. 8). In addition, a rib 13 for the purpose of increasing the bending strength of the holding member 1 is formed on the base 10 by pressing. From the protrusion 16 protruding from the one edge of the base 10 extend the first legs 20a, 20b in substantially the same direction. The second leg 30 extends from the protrusion 16 of the base 10 in the same direction as the first legs 20a, 20b. Extensions 18 extend from the protrusion 16 of the base 10 in the same direction as the second leg 30 on either side of the second leg 30.

The first legs 20a, 20b are to be fitted into the through hole 51 (see FIG. 3(a)) provided on the electrical circuit board 50 (see FIG. 3(a)) while interfering with an inside surface 51a (FIG. 3(a)) of the through hole 51 (see FIG. 3(a)). The first legs 20a, 20b are substantially symmetrical and are formed by bending a long, thin sheet extending from one end of the protrusion 16. The first legs 20a comprise a transition section 21a, 21b extending from the protrusion 16 and a fitting section 22a, 22b that extends continuously from the transition section 21a, 21b that is fitted into the through hole 51 (see FIG. 3(a)). The transition section 21a, 21b further comprises a vertical section 23a, 23b that extends from the protrusion 16 and is bent at approximately 90 degrees to be substantially perpendicular to both a mounting surface 50a (see FIG. 3(a)) of the electrical circuit board 50 (see FIG. 3(a)) and the protrusion 16, and a horizontal section 24a, 24b that extends from the vertical section 23a, 23b and is bent at approximately 90 degrees and continues so that it is substantially perpendicular to the protrusion 16 and substantially parallel to the mounting surface 50a (see FIG. 3(a)). The fitting section 22a, 22b extends continuously from the horizontal section 24a, 24b and is bent at approximately 90 degrees so as to be substantially perpendicular to both the protrusion 16 and the mounting surface 50a (see FIG. 3(a)).

Each of the first legs 20a, 20b passes through the transition sections 21a, 21b and extends in substantially the same direction in the fitting sections 22a, 22b. In addition, the first legs 20a, 20b are disposed such that the fitting sections 22a, 22b are opposed to each other. The first legs 20a, 20b, when fitted into the through hole 51 (see FIG. 3(a), are thereby in area contact with the inside surface 51a (see FIG. 3(a)) of the through hole 51 (see FIG. 3(a)). The fitting sections 22a, 22b of the first legs 20a, 20b extend in substantially the same direction, but they are not parallel. Specifically, the fitting sections 22a, 22b have a maximum gap there between at intermediate positions 26a, 26b, while a distance between the fitting sections 22a, 22b narrows at tip ends 27a, 27b, so they are gently curved. In other words, when the fitting sections 22a, 22b are viewed as a unit, the fitting sections 22a, 22b of the first legs 20a, 20b would be the widest at the intermediate positions 26a, 26b and then narrow to the tip ends 27a, 27b.

The first legs 20a, 20b form springs that are supported at the base 10 and fit into the through hole 51 (see FIG. 3(a)) in a state of elastic displacement. The holding member 1 thereby holds the connector 80 (see FIG. 8) such that the connector 80 (see FIG. 8) will not fall out under its own weight when the electrical circuit board 50 (see FIG. 8) is inverted prior to soldering. Here, it is necessary to strengthen the spring in order to prevent the first legs 20a, 20b from coming out of the through hole 51 (see FIG. 3(a)). According to the holding member 1, the first legs 20a, 20b are in area contact with the inside surface 51a (see FIG. 3(a)) of the through hole 51 (see FIG. 3(a)), so the spring can be made sufficiently strong without damaging the inside surface 51a (see FIG. 3(a)) of the through hole 51 (see FIG. 3(a)).

A substantially long leg protrusion 28a, 28b extending in the direction of the first legs 20a, 20b is formed by pressing upon the first legs 20a, 20b, in a center width-wise of the fitting section 22a, 22b. The leg protrusions 28a, 28b have the shape of bumps facing outward from the first legs 20a, 20b and are disposed so as to oppose each other. In forming the leg protrusions 28a, 28b, the shapes of the first legs 20a, 20b are such that they follow the inside surface 51a (see FIG. 3(a)) of the through hole 51 (see FIG. 3(a)) into which they are inserted. This further suppresses damage to the inside surface 51a (see FIG. 3(a)) of the through hole 51 (see FIG. 3(a)).

The second leg 30 extends from the protrusion 16 of the base 10 in the same direction as the first legs 20a, 20b, in the space between the first legs 20a, 20b. More specifically, the second leg 30 comprises a transition section 31 extending from the protrusion 16 bent at approximately 90 degrees, along with a fitting section 32 that extends continuously from the transition section 31 and is bent at approximately 90 degrees from the transition section 31. The fitting section 32 is inserted into the through hole 51 (see FIG. 3(a)) of the electrical circuit board 50 (see FIG. 3(a)). The second leg 30 is disposed between the first legs 20a, 20b, so even though it is inserted into the through hole 51 (see FIG. 3(a)) of the electrical circuit board 50 (see FIG. 3(a)) together with the first legs 20a, 20b, it does not directly interfere with the inside surface 51a (see FIG. 3(a)) of the through hole 51 (see FIG. 3(a)). The second leg 30 is disposed orthogonally to the first legs 20a, 20b. In other words, the second leg 30 is disposed such that its edge surfaces 33 face the first legs 20a, 20b. In addition, each of the first legs 20a, 20b is disposed at a position such that a gap with a constant width away from the edge surface 33 of the second leg 30 is maintained. In other words, the fitting sections 22a, 22b of the first legs 20a, 20b have a shape such that they are widest at the intermediate positions 26a, 26b and narrow at the tip ends 27a, 27b. Correspondingly, the second leg 30 is formed so that it is widest near the intermediate positions 26a, 26b and narrow near the tip ends 27a, 27b. The gap between the edge surfaces 33 of the second leg 30 and the first legs 20a, 20b is of such a width that the molten solder 61 will flow therein due to capillary action. More specifically, the average width is approximately 0.4 mm.

The extensions 18 form a fillet on an upper surface of the electrical circuit board 50 (see FIG. 3(a)) that further soaks the molten solder 61 up by capillary action through the through hole 51 (see FIG. 3(a)) reaching the upper surface of the electrical circuit board 50 (see FIG. 3(a)). The extensions 18 and the horizontal sections 24a, 24b of the first legs 20a, 20b are disposed close to each other so as to narrow the gap through which the molten solder 61 flows in.

As shown in FIGS. 3(a)-(c), the through hole 51 is formed in the electrical circuit board 50, and a copper-plate layer (not shown) is formed upon the inside surface 51a (see FIG. 3(a)) of the through hole 51 and on the electrical circuit board 50 in the vicinity of the through hole 51. The thickness of the electrical circuit board 50 is preferably no less than 1.2 mm and no more than 1.6 mm.

As shown in FIG. 3(b), when the holding member 1 is pushed in from a side of a mounting surface 50a of the electrical circuit board 50 in a direction of the arrow, the holding member 1 is inserted into the through hole 51. More specifically, the first legs 20a, 20b and the second leg 30 are inserted into the through hole 51. Here, the fitting sections 22a, 22b of the first legs 20a, 20b are formed so that their width on the outside is larger than an inside diameter of the through hole 51. For this reason, the first legs 20a, 20b deform elastically and, at the same time, fit in while interfering with the inside surface 51a of the through hole 51 due to the restoration force of deformation. In addition, the portions of the fitting sections 22a, 22b of the first legs 20a, 20b at the intermediate positions 26a, 26b where the gap between them is widest passes through the through hole 51.

In the holding member 1 according to this embodiment, the first legs 20a, 20b that interfere with the inside surface 51a of the through hole 51 are disposed in an orientation opposed to each other. For this reason, in the process of the first legs 20a, 20b being fitted into the through hole 51, and in a fitted state, the first legs 20a, 20b undergo elastic deformation in the thickness direction rather than the width direction. Accordingly, the holding member 1 is able to adapt even if the precision in the diameter of the through hole 51 is decreased in comparison to the past, so productivity is increased. The holding member 1 is also able to adapt to through holes (not shown) that have a shape other than a circular shape, for example, an oval or various other plane shapes. In addition, the first legs 20a, 20b are in area contact with the inside surface 51a of the through hole 51, so it is possible to decrease damage to the inside surface 51a of the through hole 51 on which a copper-plate layer is formed. Here, it is necessary to strengthen the spring in order to prevent the first legs 20a, 20b from coming out of the through hole 51. According to the holding member 1, the inside surface 51a of the through hole 51 is not damaged so the spring can be made sufficiently strong.

Here follows a description of a mounting structure 60 by which the holding member 1 is secured by the solder 61 to the electrical circuit board 50, along with the process by which soldering is done in the solder flow process. In the solder flow process, the holding member 1 inserted into the through hole 51 is soldered to the electrical circuit board 50 together with contacts 81 of the connector 80 (see FIG. 8).

FIGS. 4 and 5 illustrate the mounting structure 60 wherein the holding member 1 is secured by the solder 61 to the electrical circuit board 50 and, at the same time, illustrate the appearance where the molten solder 61 adheres to the electrical circuit board 50 and the holding member 1. Here follows a description of the solder 61 in the molten state in the solder flow process and solid solder 61 formed by the solidification of the molten solder 61, with the same symbol 61 applied to both.

In the solder flow process, a solder surface 50b of the electrical circuit board 50 is soaked into the molten solder 61 in the state in which the holding member 1 is fitted into the through hole 51. The holding member 1 and the copper-plate layer (not shown) formed on the inside surface 51a of the through hole 51 and its vicinity are then wetted with the molten solder 61. The molten solder 61 travels along the surface of the first legs 20a, 20b and the inside surface 51a of the through hole 51 and is soaked up into the interior of the through hole 51. The second leg 30 is disposed between the first legs 20a, 20b, so the molten solder 61 travels also along the surface of the second leg 30 and is soaked up. Moreover, the gap between the first legs 20a, 20b and the edge surfaces 33 of the second leg 30 has the proper width such that the molten solder 61 flows in by capillary action. The molten solder 61 is thus soaked up along the gap between the first legs 20a, 20b and the edge surfaces 33 of the second leg 30 by capillary action. Ultimately, the molten solder 61 soaked up into the interior of the through hole 51 rises along the surface of the horizontal section 24a, 24b of the first legs 20a, 20b. When the molten solder 61 touches a tip of the extensions 18, it rises further along the gap between the first legs 20a, 20b and the extensions 18. As a result, as shown in FIG. 5, the molten solder 61 completely buries the through hole 51 and is soaked up to above the mounting surface 50a of the electrical circuit board 50 from the through hole 51. Moreover, a solder fillet that covers the mounting surface 50a of the electrical circuit board 50 and the vertical section 23a, 23b and the horizontal section 24a, 24b of the first legs 20a, 20b is formed upon the mounting surface 50a of the electrical circuit board 50.

The mounting structure 60 is formed by the cooling and solidification of the molten solder 61 after the solder flow process. The molten solder 61 forms a solder fillet that covers the first legs 20a, 20b and the second leg 30 upon the soldering surface 50b of the electrical circuit board 50, and also forms a solder fillet that covers the vertical section 23a, 23b and the horizontal section 24a, 24b of the first legs 20a, 20b also on the mounting surface 50a. Note that the mounting structure 60 shown in FIGS. 4 and 5 is equivalent to one example of the mounting structure 60 according to the present invention.

According to the mounting structure 60, the first legs 20a, 20b and the second leg 30 of the holding member 1 and the electrical circuit board 50 are soldered to each other over a broad range, so the holding member 1 is solidly secured to the electrical circuit board 50. In other words, in the case in which the holding member 1 is attached to the connector 80 (see FIG. 8), the strength of attachment of the connector 80 (see FIG. 8) to the electrical circuit board 50 is high. In addition, solder is a soft metal, so even if the space between the first legs 20a, 20b is filled with the solder alone, it will readily deform under withdrawal forces. Moreover, according to the mounting structure 60 of this preferred embodiment, the second leg 30 is disposed in the space between the first legs 20a, 20b, so the solder layer that fills the through hole 51 is thin and the second leg 30 absorbs external forces. Accordingly, it is resistant to deformation under withdrawal forces.

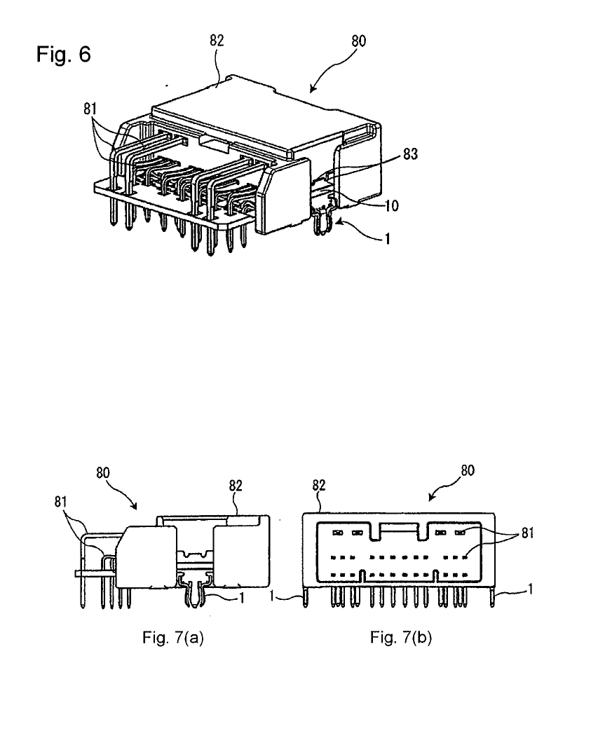

Here follows a description of the connector 80 that is held to the electrical circuit board 50 by the holding member 1. As shown in FIGS. 6-7(b), the connector 80 is mounted to the electrical circuit board 50 (see FIG. 8) built into a piece of electronic equipment and is mated to another paired connector (not shown) and thus makes electrical connections between circuits on the electrical circuit board 50 (see FIG. 8) and circuits other than those on the electrical circuit board 50 (see FIG. 8).

The connector 80 comprises the holding member 1, the contacts 81 that make contact with circuits upon the electrical circuit board 50 (see FIG. 8), and the insulating housing 82 that secures the holding member 1 and the contacts 81. The holding member 1 is attached to the connector 80 by the base 10 of the holding member 1 being pressed into the groove 83 provided on the connector 80. As shown in FIG. 8, the connector 80 is held to the electrical circuit board 50 by the holding member 1 being fitted into the through hole 51. When the solder flow process is performed in this state of the electrical circuit board 50, the holding member 1 is soldered to the electrical circuit board 50.

According to the connector 80 of this embodiment, the first legs 20a, 20b fitted into the through hole 51 are disposed in an orientation opposed to each other and undergo elastic deformation in the thickness direction. Accordingly, the holding member 1 is able to adapt even if the precision in the diameter of the through hole 51 is decreased in comparison to the past. In addition, damage to the through hole 51 can be reduced. Moreover, according to the connector 80 of the embodiment, after soldering, the filled solder layer is thin and so the second leg 30 absorbs external forces (see FIG. 5). Thus, the strength of attachment to the electrical circuit board 50 is high.

Note that the connector 80 was described as one example of an electronic component according to the present invention, but the present invention is in no way limited thereto; rather it is also applicable to other electronic components that are held to an electrical circuit board by a holding member. In addition, the connector 80 according to the present invention was described using the example of soldering by the solder flow process after first attaching the holding member 1 to the connector 80, but the present invention is in no way limited thereto. For example, the holding member 1 may also be secured to the connector 80 after first soldering the holding member 1 to the electrical circuit board 50, as shown in FIGS. 3(a)-(c). Also, an example of soldering by means of the solder flow process was described in the embodiments, but the present invention is in no way limited thereto. For example, soldering may also be performed by means of the solder reflow process by filling the interior of the through hole 51 with solder paste in advance.

Further, in the embodiment of holding member 1, each of the first legs 20a, 20b was described as being disposed with the gap in which the molten solder 61 flows by capillary action from the edge surface 33 of the second leg 30, but the present invention is in no way limited thereto. It is sufficient for the second leg 30, which does not interfere with the inside surface 51a of the through hole 51, to have the edge surfaces 33 face the first legs 20a, 20b, so it may be disposed in any way such that it is not constrained by the shape of the inside surface 51a of the through hole 51 and the shape of the first legs 20a, 20b. Provided a gap in which solder flows by capillary action permits the molten solder 61 to be more readily soaked up into the through hole 51 as described in the embodiment. In addition, the holding member 1 was explained as being made of tin-plated brass, but the present invention is in no way limited thereto. The holding member 1 may be made of any metal whose surface is wetted by the molten solder 61, so the holding member 1 may be made of a copper alloy and there is no need for tin plating.

What is claimed is:

1-5. (canceled)

6. A holding member for fitting into a through hole in an electrical circuit board that secures an electrical component to the circuit board, comprising:
a plate-like base for securing to the electrical component, the base having a protrusion extending there from;
opposing plate-like first legs extending from the protrusion for securing to the through hole in the electrical circuit board; and
a plate-like second leg extending from the protrusion in the same direction as the first legs, the second leg being arranged between the first legs.

7. The holding member of claim 6, wherein the holding member is tin plated.

8. The holding member of claim 6, wherein the base includes a rib.

9. The holding member of claim 6, wherein the second leg includes a transition section that extends from the protrusion at approximately 90 degrees relative thereto.

10. The holding member of claim 6, wherein the first legs include a vertical section the extends from the protrusion at approximately 90 degrees relative thereto.

11. The holding member of claim 6, wherein extensions extend from the protrusion in the same direction as the second leg, the extensions being arranged on both sides of the second leg.

12. The holding member of claim 6, wherein each of the first legs has a fitting section including an intermediate position and a tip end, the first legs being spaced further away from each other at the intermediate positions than at the tip ends.

13. A mounting structure, comprising:
an electrical circuit board provided with at least one through hole;
an electrical component electrically connected to the electrical circuit board, the electrical component including an insulating housing; and
a holding member having a plate-like base fixed to the insulating housing, the base having a protrusion extending there from, opposing plate-like first legs extending from the protrusion and interfere with an inside surface of the through hole for securing the holding member to the through hole in the electrical circuit board, and a plate-like second leg extending from the protrusion in the same direction as the first legs, the second leg being arranged between the first legs.

14. The mounting structure of claim 13, wherein the holding member is tin plated.

15. The mounting structure of claim 13, wherein the base includes a rib.

16. The mounting structure of claim 13, wherein the second leg includes a transition section that extends from the protrusion at approximately 90 degrees relative thereto.

17. The mounting structure of claim 13, wherein the first legs include a vertical section the extends from the protrusion at approximately 90 degrees relative thereto.

18. The mounting structure of claim 13, wherein extensions extend from the protrusion in the same direction as the second leg, the extensions being arranged on both sides of the second leg.

19. The mounting structure of claim 13, wherein each of the first legs has a fitting section including an intermediate position and a tip end, the first legs being spaced further away from each other at the intermediate positions than at the tip ends.

20. The mounting structure of claim 13, wherein the through hole is provided with solder.
